(19) United States
(12) Patent Application Publication
(10) Pub. No.: US 2026/0364984 A1
(43) Pub. Date: Nov. 19, 2026

(54) ADJUSTABLE TRAILER COMPONENT

(71) Applicant: YUPING LV, Daye (CN)

(72) Inventor: YUPING LV, Daye (CN)

(21) Appl. No.: 19/206,247

(22) Filed: May 13, 2025

(51) Int. Cl. B60D 1/42; B60D 1/06; B60D 1/52

(52) U.S. Cl. CPC B60D 1/42; B60D 1/06; B60D 1/52

(57) ABSTRACT

An adjustable trailer component is provided, which includes a trailer arm connection rod configured to install a towing vehicle and a towing ball connection rod configured to install a trailer. The towing ball connection rod is fixedly connected to the trailer arm connection rod through an adjustable component, one end of the towing ball connection rod is fixedly provided with a towing ball seat. The towing ball seat is detachably provided with the towing ball connection component. The beneficial effect of the present disclosure is that it not only has the function of connecting the towing vehicle and the trailer, but also can conveniently adjust up-and-lower heights of the towing ball connection rod and the towing arm connection rod, which can be well applied to different trailer towing operations, has a wide range of applications, and the towing ball is easy to assemble and suitable for application and use.

### TECHNICAL FIELD

The present disclosure relates to the field of trailer components technologies, and in particular, to an adjustable trailer component.

### BACKGROUND

Trailer components are an important part of a trailer (or tractor), widely used in the field of transportation, especially in long-distance transportation, cargo handling, and commercial vehicles. Through these components, the trailer can be safely and effectively connected to the tractor to achieve load transportation.

The existing trailer components are usually fixed in position and cannot adjust the height between the towing ball connection rod and the trailer arm connection rod according to usage. Different trailers often require towing ball connection rods of different heights, so the use of existing trailer components is not convenient enough.

Therefore, an adjustable trailer component is provided.

### SUMMARY

Therefore, the present disclosure provides an adjustable trailer component to solve problems raised in the background technology mentioned above.

In order to achieve the above objectives, the present disclosure provides the following technical solution: an adjustable trailer component, including a trailer arm connection rod configured to install a towing vehicle and a towing ball connection rod configured to install a trailer, where the towing ball connection rod is fixedly connected to the trailer arm connection rod through an adjustable component; one end of the towing ball connection rod is fixedly provided with a towing ball seat, and the towing ball seat is detachably provided with a towing ball connection component;
where the adjustable component includes two clips, the trailer arm connection rod is rotatably connected to tops of the two clips through a first pin shaft, and the towing ball connection rod is rotatably connected to bottoms of the two clips through a second pin shaft;
both upper and lower of the two clips are provided with a plurality of adjusting holes, and corresponding angle numerical indicators are provided on sides of the adjusting holes;
one end of the trailer arm connection rod is fixed to uppers of the two clips through a first pin, and one end of the towing ball connection rod is fixed to lowers of the two clips through a second pin;
the trailer arm connection rod is arranged to be parallel to the towing ball connection rod.

In some embodiments of the present disclosure, the first pin is capable of inserting into any adjusting hole located at uppers of the two clips, and the second pin is capable of inserting into any adjusting hole located at lowers of the two clips; when the trailer arm connection rod and the towing ball connection rod are parallel, the first pin and the second pin are respectively inserted into the adjusting holes located at upper and lower of the two clips with the same angle numerical indicator.

In some embodiments of the present disclosure, the towing ball connection component includes a connection perforation vertically provided in a middle of the towing ball seat, and a first cylindrical keyway is vertically provided on one side of a hole wall of the connection perforation.

In some embodiments of the present disclosure, the towing ball connection component further includes an upper towing ball and a lower towing ball, and opposite ends of the upper towing ball and the lower towing ball are fixedly provided with a towing ball shaft body; the upper towing ball, the lower towing ball, and the towing ball shaft body are an integrated structure.

In some embodiments of the present disclosure, the lower towing ball and the towing ball shaft body pass through the connection perforation; a surface of the towing ball shaft body abuts against the hole wall of the connection perforation, one side of the towing ball shaft body is provided with a second cylindrical keyway, and the second cylindrical keyway is embedded with a metal column block, the metal column block is inserted into the first cylindrical keyway.

In some embodiments of the present disclosure, a top of the towing ball shaft body is fixedly provided with an upper cover, a bottom of the towing ball shaft body is threadedly connected with a movable bottom cover, and a circular receiving groove is provided at a center of a bottom of the towing ball seat, and the circular receiving groove is communicated to the connection perforation; a diameter of the circular receiving groove is larger than a bore diameter of the connection perforation.

In some embodiments of the present disclosure, a bottom of the upper cover abuts against a top of the towing ball seat, a top of the movable bottom cover is located in the circular receiving groove, and the movable bottom cover abuts against the bottom of the towing ball seat.

The beneficial effects of the present disclosure are: through the coordinated use of the trailer arm connection rod, the towing ball connection rod, the adjusting component, the towing ball seat, and the towing ball connection component, it not only has the function of connecting the towing vehicle and the trailer, but also can conveniently adjust a vertical height between the towing ball connection rod and the towing arm connection rod, which can be well applied to different towing operations, has a wide range of applications, and the towing ball is easy to assemble, suitable for application and use.

### BRIEF DESCRIPTION OF DRAWINGS

FIG. 1 is a perspective structural view of the present disclosure.

FIG. 2 is an exploded structure view of the present disclosure.

FIG. 3 is an exploded structure view of the present disclosure.

FIG. 4 is a schematic structural diagram of the present disclosure when a towing ball connection rod is located at a lowest position.

FIG. 5 is a schematic structural diagram of the present disclosure when the towing ball connection rod is located at a highest position.

Numeral reference: 1—trailer arm connection rod; 2—towing ball connection rod; 3—towing ball seat; 4—clip; 5—first pin shaft; 6—second pin shaft; 7—adjusting hole; 8—angle numerical indicator; 9—first pin; 10—second pin; 11—connection perforation; 12—first cylindrical keyway; 13—upper towing ball; 14—lower towing ball; 15—towing ball shaft body; 16—second cylindrical keyway; 17—metal column block; 18—upper cover; 19—movable bottom cover; 20—circular receiving groove.

### DESCRIPTION OF EMBODIMENTS

The preferred embodiments of the present disclosure are described below in combination with the accompanying drawings. It should be understood that the preferred embodiments described herein are only for illustrating and explaining the present disclosure, and are not intended to limit the present disclosure.

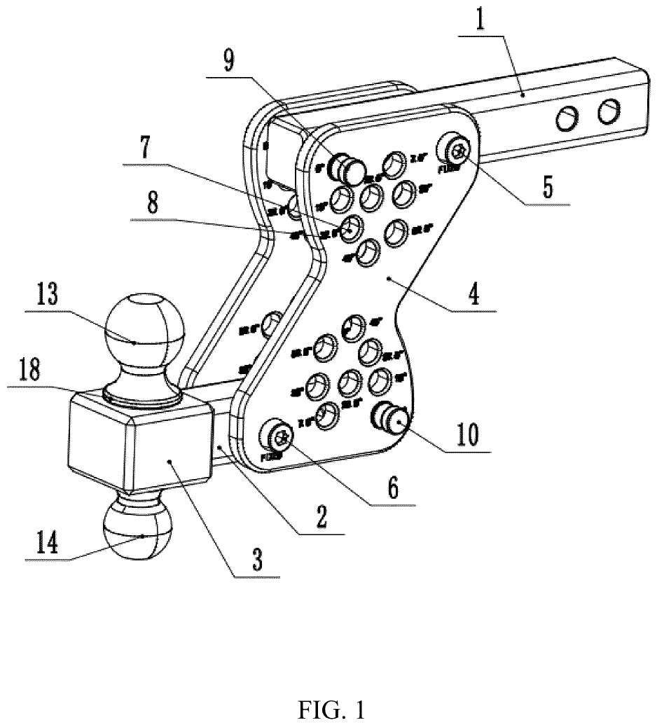

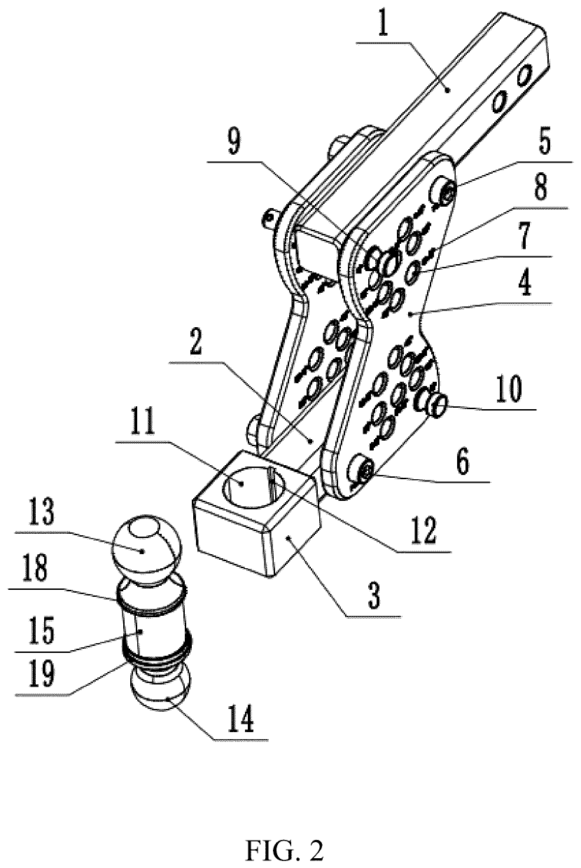

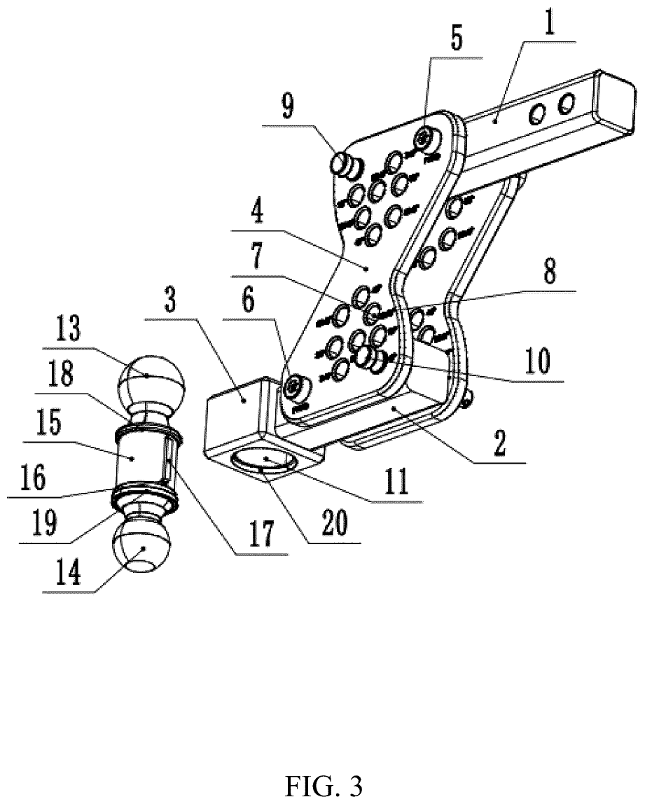

Please refer to FIGS. 1-5. An adjustable trailer component provided by the present disclosure includes a trailer arm connection rod 1 configured to install a towing vehicle and a towing ball connection rod 2 configured to install a trailer. The towing ball connection rod 2 is fixedly connected to the trailer arm connection rod 1 through an adjustable component, and one end of the towing ball connection rod 2 is fixedly provided with a towing ball seat 3. A towing ball connection component is detachably provided on the towing ball seat 3.

The adjustable component includes two clips 4. The trailer arm connection rod 1 is rotatably connected to tops of the two clips 4 through a first pin shaft 5, and the towing ball connection rod 2 is rotatably connected to bottoms of the two clips 4 through a second pin shaft 6. It should be noted that both top and bottom of the two clips 4 are both provided with a fixed hole position (not marked in the figure) for installing the first pin shaft 5 and the second pin shaft 6. The upper and lower of the two clips 4 are provided with a plurality of adjusting holes 7, and sides of the adjusting holes 7 are provided with corresponding angle numerical indicators 8. It should be noted that in the present disclosure, the plurality of adjusting holes 7 are divided into four groups, and the four groups of adjusting holes 7 are located at the upper and lower of the two clips 4, the number of the adjusting holes 7 in each group may be 8. The angle numerical indicators 8 provided on one side of the eight adjusting holes 7 in the same group is prioritized to be 0°, 7.5°, 15°, 22.5°, 30°, 37.5°, 45°, 52.5°, and an upper 0° hole position of the clips 4 corresponds to a lower 0° hole position of the clips 4, an upper 47.5° hole position of the clips 4 corresponds to a lower 7.5° hole position of the clips 4, an upper 15° hole position of the clips 4 corresponds to a lower 15° hole position of the clips 4, an upper 22.5° hole position of the clips 4 corresponds to a lower 22.5° hole position of the clips 4, an upper 30° hole position of the clips 4 corresponds to a lower 30° hole position of the clips 4, an upper 37.5° hole position of the clips 4 corresponds to a lower 37.5° hole position of the clips 4, an upper 45° hole position of the clips 4 corresponds to a lower 45° hole position of the clips 4, and an upper 52.5° hole position of the clips 4 corresponds to a lower 52.5° hole position of the clips 4. One end of trailer arm connection rod 1 is fixed to the upper of two clips 4 through a first pin 9, and one end of the towing ball connection rod 2 is fixed to the lower of two clips 4 through a second pin 10. The trailer arm connection rod 1 is parallel to the towing ball connection rod 2.

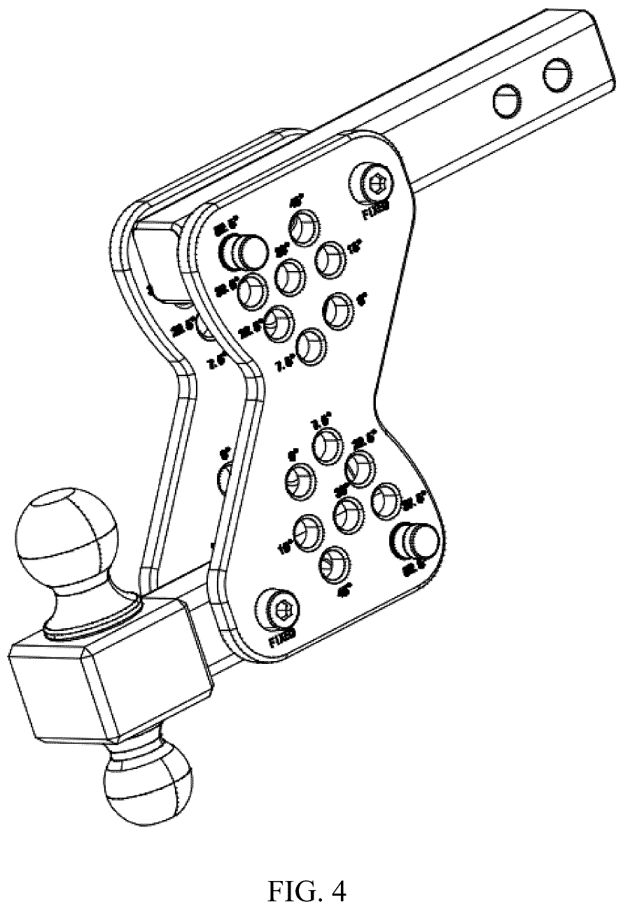

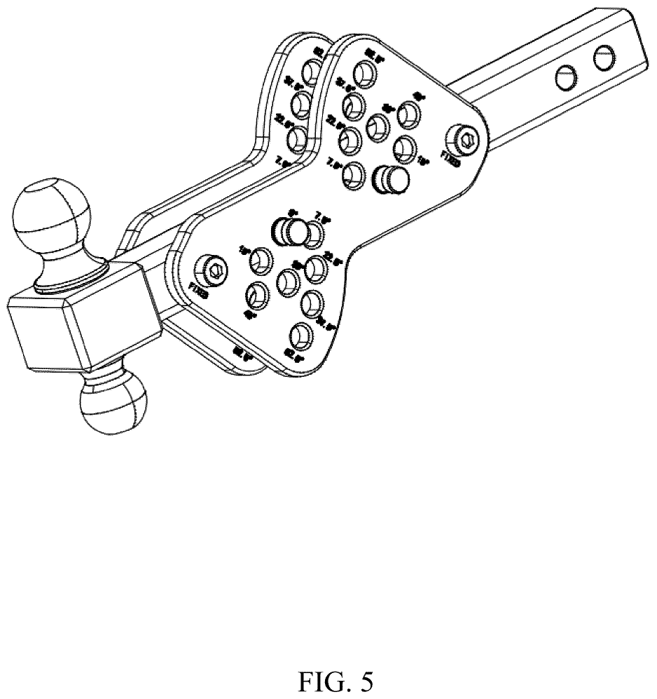

The first pin 9 can be inserted into any adjusting hole 7 located at the upper of the clips 4, and the second pin 10 can be inserted into any adjusting hole 7 located at the lower of the clips 4. When the trailer arm connection rod 1 is parallel to the towing ball connection rod 2, the first pin 9 and the second pin 10 are respectively inserted into the adjusting holes 7 located at the upper and lower of the clips 4 with the same angle numerical indicator 8. In an implementation mode, as shown in FIG. 4, when the first pin 9 and the second pin 10 are respectively inserted into the adjusting holes 7 located at the upper and lower of the clips 4 with an angle numerical indicator 8 of 52.5°, the trailer arm connection rod 1 is parallel to the towing ball connection rod 2, and the towing ball connection rod 2 is located at a lowest position. As shown in FIG. 5, when the first pin 9 and the second pin 10 are respectively inserted into the adjusting holes 7 located on the upper and lower of the clips 4 with an angle numerical indicator 8 of 0°, at this time, the trailer arm connection rod 1 is parallel to the towing ball connection rod 2, and the towing ball connection rod 2 is located at a highest position. Thus, a user can adjust a height of the towing ball connection rod 2 by adjusting the adjusting hole 7 from 0° hole position to 52.5° hole position in sequence, so that the height of the towing ball connection rod 2 will be separated from an original position by one inch. That is, as the angle value increases, the height of the towing ball connection rod 2 is decreased, thereby adjusting different heights of the towing ball connection rod 2. Besides that, the trailer arm connection rod 1 and the towing ball connection rod 2 can be connected in a forward or reverse manner. When installed in the forward direction, that is, when the trailer arm connection rod 1 is provided on tops of the clips 4, the towing ball connection rod 2 is provided on the bottoms of the clips 4. As the angle value increases, the height of the towing ball connection rod 2 is decreased downwards. When assembled in a reversed manner, and the trailer arm connection rod 1 is provided at bottoms of the clips 4, and the towing ball connection rod 2 is provided at tops of the clips 4, the height of the towing ball connection rod 2 is increased as the angle value is increased.

In summary, the adjustable component not only has a function of connecting the towing vehicle and the trailer, but also allows the user to adjust it by inserting the first pin 9 and the second pin 10 into the corresponding positions without disassembling the two clips 4 and the trailer arm connection rod 1 and the towing ball connection rod 2. It can easily adjust the height between the towing ball connection rod 2 and the trailer arm connection rod 1, rendering it suitable for different trailer towing operations and has a wide range of applications.

The towing ball connection component includes a connection perforation 11, and the connection perforation 11 is vertically provided in a middle of the towing ball seat 3. A first cylindrical keyway 12 is vertically provided on one side of a hole wall of the connection perforation 11. The towing ball connection component further includes an upper towing ball 13 and a lower towing ball 14. Opposite ends of the upper towing ball 13 and the lower towing ball 14 are fixedly provided with a towing ball shaft body 15. The upper towing ball 13, the lower towing ball 14, and the towing ball shaft body 15 are an integrated structure. The lower towing ball 14 and the towing ball shaft body 15 pass through the connection perforation 11, and a surface of the towing ball shaft body 15 abuts against the hole wall of the connection perforation 11. One side of the towing ball shaft body 15 is provided with a second cylindrical keyway 16, and the second cylindrical keyway 16 is embedded with a metal column block. 17. The metal column block 17 is inserted into the first cylindrical keyway 12. In an implementation mode, under an action of the metal column block 17, it can effectively prevent the towing ball shaft body 15 from rotating inside the connection perforation 11.

A top of the towing ball shaft body 15 is fixedly provided with an upper cover 18, and a bottom of the towing ball shaft body 15 is threadedly connected with a movable bottom cover 19. A center of a bottom of the towing ball seat 3 is provided with a circular receiving groove 20, and the circular receiving groove 20 is communicated to the connection perforation 11. A diameter of the circular receiving groove 20 is larger than a bore diameter of the connection perforation 11. A bottom of the upper cover 18 abuts against a top of the towing ball seat 3, and a top of the movable bottom cover 19 is located inside the circular receiving groove 20. The movable bottom cover 19 abuts against the bottom of the towing ball seat 3. In an implementation mode, under an action of the upper cover 18, the upper towing ball 13, the lower towing ball 14, and the towing ball shaft body 15 of the integrated structure cannot move down. Under the action of the movable bottom cover 19, the upper towing ball 13, the lower towing ball 14, and the towing ball shaft body 15 of the integrated structure cannot move up. With the use of the metal column block 17, it can effectively ensure an assemble stability of the upper towing ball 13, the lower towing ball 14, and the towing ball shaft body 15 of the integrated structure on the towing ball seat 3, and the movable bottom cover 19 is easy to disassembled, so that it convenient for the user to quickly disassemble and assemble the upper towing ball 13, the lower towing ball 14, and the towing ball shaft body 15 of the integrated structure, which facilitates the assembly of the towing ball.

A use process of the present disclosure is as follows: the user adjusts a height of the towing ball connection rod 2 according to an actual required docking height of the trailer with the upper towing ball 13 and the lower towing ball 14. When adjusting, the user can adjust the hole positions of the adjusting hole 7 from 0° to 52.5° in sequence. That is, the first pin 9 and the second pin 10 are respectively inserted into the adjusting holes 7 located at the upper and lower of the clips 4 with different angle values, but the first pin 9 and the second pin 10 need to be inserted into the adjusting holes 7 with the same angle value to ensure that the trailer arm connection rod 1 and the towing ball connection rod 2 are always parallel. Therefore, this adjustable component has the function of connecting the towing vehicle and the trailer. At the same time, it is also convenient to adjust an up-and-down height between the towing ball connection rod 2 and the trailer arm connection rod 1. Thus, it can be well applied to different trailer towing operations, with a wide range of applications.

After the height adjustment of the towing ball connection rod 2 is completed, the user takes out the upper towing ball 13, the lower towing ball 14, and the towing ball shaft body 15 of the integrated structure, and the metal column block 17 is inserted into the second cylindrical keyway 16. The lower towing ball 14 and the towing ball shaft body 15 pass through the connection perforation 11 on the towing ball seat 3. When passing through, the metal column block 17 is aligned with the first cylindrical keyway 12, so that the metal column block 17 can be smoothly inserted into the first cylindrical keyway 12. Then, the movable bottom cover 19 is taken out and it is threaded onto the bottom of the towing ball shaft body 15. At this time, under the action of the upper cover 18, the upper towing ball 13, the lower towing ball 14, and the towing ball shaft body 15 of the integrated structure cannot move down. Under the action of the movable bottom cover 19, the upper towing ball 13, the lower towing ball 14, and the towing ball shaft body 15 of the integrated structure cannot move up. When used in combination with the metal column block 17, it can effectively ensure the stability of the upper towing ball 13, the lower towing ball 14, and the towing ball shaft body 15 of the integrated structure when assembled on the towing ball seat 3, and the movable bottom cover 19 is easy to disassemble and assemble, rendering it convenient for the user to quickly disassemble and assemble the upper towing ball 13, the lower towing ball 14, and the towing ball shaft body 15 of the integrated structure.

The above description is only preferred embodiments of the present disclosure, and those skilled in the art can use the technical solution described above to modify the present disclosure or modify it into an equivalent technical solution. Therefore, any minor modifications or equivalent substitutions made according to the technical solution of the present disclosure are within the protection scope claimed by the present disclosure.

What is claimed is:

1. An adjustable trailer component, comprising a trailer arm connection rod configured to install a towing vehicle and a towing ball connection rod configured to install a trailer, wherein the towing ball connection rod is fixedly connected to the trailer arm connection rod through an adjustable component; one end of the towing ball connection rod is fixedly provided with a towing ball seat, and the towing ball seat is detachably provided with a towing ball connection component;
wherein the adjustable component comprises two clips, the trailer arm connection rod is rotatably connected to tops of the two clips through a first pin shaft, and the towing ball connection rod is rotatably connected to bottoms of the two clips through a second pin shaft;
both upper and lower of the two clips are provided with a plurality of adjusting holes, and corresponding angle numerical indicators are provided on sides of the adjusting holes;
one end of the trailer arm connection rod is fixed to uppers of the two clips through a first pin, and one end of the towing ball connection rod is fixed to lowers of the two clips through a second pin;
the trailer arm connection rod is arranged to be parallel to the towing ball connection rod.

2. The adjustable trailer component according to claim 1, wherein the first pin is capable of inserting into any adjusting hole located at uppers of the two clips, and the second pin is capable of inserting into any adjusting hole located at lowers of the two clips;
when the trailer arm connection rod and the towing ball connection rod are parallel, the first pin and the second pin are respectively inserted into the adjusting holes located at upper and lower of the two clips with the same angle numerical indicator.

3. The adjustable trailer component according to claim 1, wherein the towing ball connection component comprises a connection perforation vertically provided in a middle of the towing ball seat, and a first cylindrical keyway is vertically provided on one side of a hole wall of the connection perforation.

4. The adjustable trailer component according to claim 3, wherein the towing ball connection component further comprises an upper towing ball and a lower towing ball, and opposite ends of the upper towing ball and the lower towing ball are fixedly provided with a towing ball shaft body;
the upper towing ball, the lower towing ball, and the towing ball shaft body are an integrated structure.

5. The adjustable trailer component according to claim 4, wherein the lower towing ball and the towing ball shaft body pass through the connection perforation,
a surface of the towing ball shaft body abuts against the hole wall of the connection perforation, one side of the towing ball shaft body is provided with a second cylindrical keyway, and the second cylindrical keyway is embedded with a metal column block, the metal column block is inserted into the first cylindrical keyway.

6. The adjustable trailer component according to claim 5, wherein a top of the towing ball shaft body is fixedly provided with an upper cover,
a bottom of the towing ball shaft body is threadedly connected with a movable bottom cover, and a circular receiving groove is provided at a center of a bottom of the towing ball seat, and the circular receiving groove is communicated to the connection perforation;
a diameter of the circular receiving groove is larger than a bore diameter of the connection perforation.

7. The adjustable trailer component according to claim 6, wherein a bottom of the upper cover abuts against a top of the towing ball seat, a top of the movable bottom cover is located in the circular receiving groove, and the movable bottom cover abuts against the bottom of the towing ball seat.
